(19) United States
(12) Patent Application Publication
(10) Pub. No.: US 2023/0025670 A1
(43) Pub. Date: Jan. 26, 2023

(54) FLAME-RETARDANT POLYMER COMPOSITION

(71) Applicant: Carl Freudenberg KG, Weinheim (DE)

(72) Inventor: Arthur Lanziner, Heidelberg (DE)

(21) Appl. No.: 17/779,134

(22) PCT Filed: Nov. 12, 2020
(86) PCT No.: PCT/EP2020/081898

§ 371 Date: May 24, 2022

(30) Foreign Application Priority Data
Nov. 28, 2019 (DE) 10 2019 132 294.4

(51) Int. Cl. C08L 23/16; C08J 3/24; C08L 81/04; C08J 3/00

(52) U.S. Cl. CPC C08L 23/16; C08J 3/24; C08L 81/04; C08J 3/005; C08J 2323/16; C08J 2381/04

(57) ABSTRACT

A flame-retardant polymer composition comprises at least one elastomeric polymer that includes at least one monomer incorporated by polymerization. The at least one monomer comprises at least one of C2-C30 alkylenes. The flame-retardant polymer composition further comprises polyarylene sulfide. The polyarylene sulfide is present in a particle form and/or in a fiber form.

### CROSS-REFERENCE TO PRIOR APPLICATIONS

This application is a U.S. National Phase application under 35 U.S.C. § 371 of International Application No. PCT/EP2020/081898, filed on Nov. 12, 2020, and claims benefit to German Patent Application No. DE 10 2019 132 294.4, filed on Nov. 28, 2019. The International Application was published in German on Jun. 3, 2021 as WO 2021/104889 A1 under PCT Article 21(2).

### FIELD

Embodiments of the present invention relate to a flame-retardant polymer composition, a process of preparing a flame-retardant polymer composition, the use of polyarylene sulfide as a flame retardant, and the use of the flame-retardant polymer composition.

### BACKGROUND

Polyolefin polymers are successfully used as molding materials in large quantities, e. g. in the automotive industry, electrical engineering, household appliances or in mechanical engineering. There is often a necessity to finish the polymers in such a flame-retardant manner that they fulfil the technical requirements of flammability tests, e. g. of the test according to UL 94 (Underwriter Laboratories, USA).

To increase the flame-retardant properties of materials and molding materials on the basis of polyolefin polymers, flame retardants, such as organic halogen compounds, organic phosphate compositions, antimony, tin and/or zinc compounds are usually added. However, many flame retardants are regarded as extreme health hazards and/or are ecologically problematic.

To avoid the above-mentioned drawbacks, flame retardants that are health-wise and ecologically harmless, such as magnesium hydroxide and/or aluminum hydroxide can be introduced into polyolefin polymers.

In EP 0 605 861, halogen-free flame-retardant molding materials on polyamide basis are described. The polyamide is finished with magnesium hydroxide and polyphenylene sulfide.

Magnesium hydroxide, aluminium hydroxide and organic phosphate compounds have the drawback, however, that their flame-retardant performance is not satisfactory. They can only fulfil a high standard for molding materials on the basis of self-cross-linked polyolefin polymers, and can be categorized as UL 94 V0 in the flammability test according to UL 94.

Molding materials on the basis of sulfur-cross-linked polyolefin polymers shows several drawbacks in their application profile, however. They are less heat resistant and less pressure-deformation resistant than corresponding peroxidically cross-linked polyolefin polymers. However, molding materials with advantageous application-specific properties on the basis of peroxidically cross-linked polyolefin polymers in combination with well-known flame retardants that are health-wise and ecologically unproblematic, such as magnesium hydroxide, aluminum hydroxide and/or organic phosphate compounds, can be categorized only as UL 94 V2 or, at best, as UL 94 V1, in the flammability test according to UL 94.

WO 2018/193019 describes a polymer alloy containing polyphenylene sulfide (PSS) and at least one thermoplastic vulcanizate. A thermoplastic vulcanizate as in WO 2018/193019 is both a thermoplastic fluorinated polymer and also a dispersed phase of a fluorine-containing elastomer. The polymer alloy is obtained by melt-mixing the two components.

EP 2418255 describes a cross-linked polymer composition containing polyphenylene sulfide (PSS) and an impact toughness modifier/elasticator. To obtain the cross-linked polymer composition, the components, such as PPS and the impact toughness modifiers/elasticators are melt-mixed. The cross-linked polymer contains large amounts of PPS, namely 50 to 80 wt %, preferably even 70 to 80 wt %.

U.S. Pat. No. 6,303,708 B1 describes a poly(phenyleneether)/Poly(arylene sulfide)-resin composition. The composition additionally also contains a salt, e. g., Na, Mg, Li, K salts etc. and elastomeric block copolymers. The present composition is prepared by melt-mixing (extrusion). Again, large amounts of PPS (at least 50 wt %) have to be used in the resin to achieve the desired properties.

In melt-mixing, the PPS is worked into the polymer (elastomer) in a molten state. High temperatures can damage the polymer chains, however. In the worst case, this can lead to a decomposition of the elastomer. This results in the desired properties of the polymer composition no longer being achieved. Moreover, the use of large amounts of PPS leads to a deterioration of the mechanical properties, since the material becomes the harder the larger the amount of PPS. In other words, there continues to be a need for polymer compositions which have satisfactory application-specific properties, such as heat, weather and fatigue resistance or good sealing properties.

### SUMMARY

Embodiments of the present invention provide a flame-retardant polymer composition. The flame-retardant polymer composition comprises at least one elastomeric polymer that includes at least one monomer incorporated by polymerization. The at least one monomer comprises at least one of C2-C30 alkylenes. The flame-retardant polymer composition further comprises polyarylene sulfide. The polyarylene sulfide is present in a particle form and/or in a fiber form.

### DETAILED DESCRIPTION

Embodiments of the present invention provide a flame-retardant polymer composition on the basis of polyolefin polymers, which has both an advantageous property profile and a high flame-retardant performance.

The flame-retardant polymer composition according to embodiments of the present invention has the following advantages:
The flame-protective properties, especially of peroxidically cross-linked polymers, are improved.
The polymers and products based thereon have advantageous application-specific properties, e. g. good heat, weather and fatigue resistance.
The polymers and products based thereon have good sealing properties.

A first aspect of the invention provides a flame-retardant polymer composition, comprising:

a) at least one elastomeric polymer including at least one monomer incorporated by polymerization, which is selected from C₂-C₃₀ alkylenes,
b) polyarylene sulfide.

Preferred is a flame-retardant polymer composition, comprising:

a) at least one elastomeric polymer including at least one monomer incorporated by polymerization, which is selected from C₂-C₃₀ alkylenes,
b) polyarylene sulfide,
wherein component b) is present in particle form and/or in fiber form.

A further aspect of the present invention provides a method of producing a curable flame-retardant polymer composition, comprising the steps of:

i) providing at least one curable elastomer a),
ii) providing at least one polyarylene sulfide b),
iii) mixing the curable elastomer a) and the polyarylene sulfide b) at a temperature higher than the plasticization temperature of the elastomer a) and lower than the melting point of the polyarylene sulfide b),
iv) adding a curing agent, in particular a peroxide curing agent, to the polymer mixture to form a curable elastomer composition.

A further aspect of the present invention relates to the use of a mixture including component b) and component c) for the flame-retardant finishing of component a).

A further aspect of the present invention provides a method of producing a curable flame-retardant polymer composition, comprising the steps of:

i) providing at least one curable elastomer a),
ii) providing at least one polyarylene sulfide b),
iii) mixing the curable elastomer a) and the polyarylene sulfide b) at a temperature higher than the plasticization temperature of the elastomer a) and lower than the melting point of the polyarylene sulfide b),
iv) adding a curing agent, in particular a peroxide curing agent, to the polymer mixture to form a curable elastomer composition,
v) curing the curable elastomer composition obtained in step iv).

A further aspect of the present invention provides a cured flame-retardant polymer composition obtainable according to the method according to embodiments of the invention.

A further aspect of the present invention relates to the use of a polyarylene sulfide b) as a flame retardant for a polymer composition, comprising at least one elastomeric polymer a) as defined above and in the following.

A further aspect of the present invention relates to the use of the flame-retardant polymer composition as defined above and in the following, in automotive components, for the production of seals, in particular O-rings, frame seals, radial shaft sealing rings, bellows and valve-stem seals.

In the context of the embodiments of the present invention, C₂-C₃₀-alkylene is a linear or branched ethylenic unsaturated hydrocarbon having 2 to 30, preferably 2 to 10, in particular, 2 to 6 carbon atoms, having a C═C double bond or a plurality, preferably two, non-cumulated, C═C double bonds in any position, such as ethene, propene, 1-butene, 2-butene, isobutene, 2-methylpropene, 1,2-butylene, 2,3-butylene, isoprene, butadiene, 1-pentene, 2-pentene, 3-pentene, 2-methyl-1-butene, 3-methyl-1-butene, 2-methyl-2-butene, 3-methyl-2-butene, 2-methyl-3-butene, 3-methyl-3-butene, 1,1-dimethylpropene, 1-hexene, 2-hexene, 3-hexene, 4-hexene, 1-heptene, 1-octene, 1-nonene, 1-decene.

In the context of the embodiments of the present invention, the expression C₁-C₁₂-alkyl stands for linear and branched saturated hydrocarbon groups having 1 to 12, preferably 1 to 8, in particular, 1 to 6, carbon atoms. In particular, C₁-C₆-alkyl is, for example, methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylbutyl, 1-ethyl-1-methylpropyl or 1-ethyl-2-methylpropyl. C₁-C₄-alkyl means, for example, methyl, ethyl, propyl, 1-methylethyl, butyl, 1-methylpropyl, 2-methylpropyl or 1,1-dimethylethyl.

In the context of the embodiments of the present invention, the expression C₁-C₁₂-alkoxy stands for a linear or branched saturated C₁-C₁₂-alkyl group as defined above, which is bonded via an oxygen atom. Preferred are alkoxy groups having 1 to 8, in particular, 1 to 6 carbon atoms, particularly preferably having 1 or 4, especially 1 to 2 carbon atoms. C₁-C₁₂-alkoxy is methoxy or ethoxy. C₁-C₄-alkoxy is, e. g., methoxy, ethoxy, n-propoxy, 1-methylethoxy (isopropoxy), butoxy, 1-methylpropoxy (sec-butoxy), 2-methlypropoxy (isobutoxy) or 1,1-dimethylethoxy (tert-butoxy). C₁-C₆-alkoxy includes the meanings indicated for C₁-C₄-alkoxy and, in addition, for example, pentoxy, 1-methylbutoxy, 2-methylbutoxy, 3-methylbutoxy, 1,1-dimethylpropoxy, 1,2-dimethylpropoxy, 2,2-dimethylpropoxy, 1-ethylpropoxy, hexyloxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy and 3,3-dimethylbutoxy.

In the context of the embodiments of the present invention, the expression C₁-C₁₂-alkylthio stands for a linear or branched saturated C₁-C₁₂-alkyl group as defined above, which is bonded via a sulfur atom. It is understood to be synonymous to C₁-C₁₂-alkylsulfanyl. Preferably, alkylthio groups having 1 to 8 carbon atoms, particularly preferably having 1 to 4, in particular, 1 to 2 carbon atoms. C₁-C₁₂-alkylthio is methylsulfanyl or ethylsulfanyl. C₁-C₄-alkylsulfanyl is, for example, methylsulfanyl, ethylsulfanyl, n-propylsulfanyl, 1-methylethylsulfanyl (isopropylsulfanyl), butylsulfanyl, 1-methylpropylsulfanyl (sec-butylsulfanyl), 2-methylpropylsulfanyl (isobutylsulfanyl) or 1,1-dimethylethylsulfanyl (tert-butylsulfanyl). C₁-C₆-alkylthio includes the meanings indicated for C₁-C₄-alkylsulfanyl and, in addition, for example, also pentylsulfanyl, 1-methylbutylsulfanyl, 2-methylbutylsulfanyl, 3-methylbutylsulfanyl, 1,1-dimethylpropylsulfanyl, 1,2-dimethylpropylsulfanyl, 2,2-dimethylpropylsulfanyl, 1-ethylpropylsulfanyl, hexylsulfanyl, 1-methylpentylsulfanyl, 2-methylpentylsulfanyl, 3-methylpentylsulfanyl, 4-methylpentylsulfanyl, 1,1-dimethylbutylsulfanyl, 1,2-dimethylbutylsulfanyl, 1,3-dimethylbutylsulfanyl, 2,2-dimethylbutylsulfanyl, 2,3-dimethylbutylsulfanyl, 3,3-dimethylbutylsulfanyl, 1-ethylbutylsulfanyl, 2-ethylbutylsulfanyl, 1,1,2-trimethylpropylsulfanyl, 1,2,2-trimethylpropylsulfanyl, 1-ethyl-1-methylpropylsulfanyl or 1-ethyl-2-methylpropylsulfanyl.

The expression “aryl”, in the context of the embodiments of the present invention, comprises one- or more-core aromatic hydrocarbon groups usually having 6 to 24, preferably 6 to 14, particularly preferably 6 to 10 carbon atoms. Examples of aryl are, in particular, phenyl, naphthyl, indentyl, fluorenyl, anthracenyl, phenanthrenyl, naphthacanyl, chrysenyl, pyrenyl etc. and especially phenyl or naphthyl.

In the context of the embodiments of the present invention, the expression “alkylaryl” stands for an aryl group as defined above, which is bonded via a C₁-C₆-alkyl as defined above.

In the context of the embodiments of the present invention, the expression “arylalkyl” stands for an alkyl group as defined above, which is bonded via a C₆-C₂₄-aryl as defined above.

In the context of the embodiments of the present invention, the expression “aryloxy” stands for an aryl group as defined above, which is bonded via oxygen.

In the context of the embodiments of the present invention, the expression “arylthio” stands for an aryl group as defined above, which is bonded via sulfur.

Component a)

The flame-retardant polymer composition according to the embodiments of the invention can include, as an elastomeric polymer a), at least one uncured curable polymer or at least one cured curable polymer or at least one non-curable polymer or a combination thereof.

The flame-retardant polymer composition comprises, as component a), at least one elastomeric polymer containing at least one monomer incorporated by polymerization, which is selected from C₂-C₃₀-alkylenes.

In the context of the embodiments of the present invention, the term “elastomer” means shape-maintaining, but elastically deformable plastics having a glass transition temperature below the temperature at which the polymers are commonly used. Elastomers can be elastically deformed at tensile and compressive loads, but return to their original, non-deformed shape afterwards.

A special form of elastomers are thermoplastic elastomers which have thermoplastic properties in certain temperature ranges. Usually, at low temperatures, thermoplastic elastomers show a behavior that is comparable to classic elastomers. However, if heat is supplied, they are plastically deformable and show thermoplastic behavior.

Preferably, the elastomeric polymer a) is selected from curable elastomers.

Curing is understood to be a chemically irreversible cross-linking reaction. As a consequence of the cross-linking (curing) the macromolecules are linked to form a three-dimensional network, wherein as the degree of cross-linking (the proportion of cross-links in relation to the volume of the polymer) is increased, the more the mechanical and thermal properties, such as the strength, the e-modulus, the hardness and the toughness, are enhanced.

With elastomers, curing can be done by vulcanization, wherein sulfur-containing compounds are used here, for example, as a cross-linking agent or cross-linking promoter. Curing can also be radical, especially using peroxides.

Preferably, the elastomeric polymer a) is radically curable, in particular, peroxidically curable. Radically curable elastomeric polymers a) are those that are able to form free radicals, which can be cross-linked. To do this, the curable elastomeric polymer a) can react with a radical curing agent, resulting in cross-links. These cross-links can react, for example, with the unsaturated bonds of a cross-linking coagent. Cross-linking coagents include at least two unsaturated, preferably olefinically unsaturated, groups.

In a preferred embodiment, the elastomeric polymer a) is cross-linked by C—C single bonds. These are obtained by direct reaction of the radical sites of two polymer chains, or by the reaction of the radical position of two polymer chains with the cross-linking coagent.

In an embodiment, the elastomeric polymer a) is selected from polyurethanes, silicones, fluorosilicones, polycarbonates, ethylene-vinyl acetates (EVA), acrylonitrile/butadiene/acrylates (ABA), acrylonitrile-butadiene rubbers (ABN), acrylonitrile-butadiene styrenes (ABS), acrylonitrile-methyl methacrylates (AMMA), acrylonitrile-styrene acrylates (ASA), cellulose acetates (CA), cellulose-acetate butyrates (CAB), polysulfones (PSU), poly(meth)acrylates, polyvinyl chlorides (PVC), polyphenylene ethers (PPE=polyphenylene oxide (PPO)), polystyrenes (PS), polyamides (PA), polyolefines, e. g., polyethylene (PE) or polypropylene (PP), polyketones (PK), e. g., aliphatic polyketones or aromatic polyketones, polyetherketones, e. g., aliphatic polyetherketones or aromatic polyetherketones, polyimides (PI), polyetherimides, polyethylene terephthalates (PET), polybutylene terephthalates (PBT), fluoropolymers, polyesters, polyacetals, e. g., polyoxymethylene (POM), liquid crystal polymers, polyether sulphones (PES), epoxy resins (EP), phenolic resins, chlorosulfonates, polybutadienes, polybutylene, polyneoprenes, polynitriles, polyisoprenes, natural rubbers, copolymer rubbers, such as styrene-isoprene styrenes (SIS), styrene-butadiene styrenes (SBS), ethylene-propylenes (EPR), ethylene-propylene-diene rubbers (EPDM), styrene-butadiene rubbers (SBR), and their copolymers and mixtures (blends) thereof.

In a special embodiment, polymer a) is selected from diene rubbers. Particularly preferably, polymer a) will be selected from ethylene-propylene-diene rubbers (EPDM), natural rubbers (NR), isoprene rubbers (IR), butadiene rubbers (BR), styrene-butadiene rubbers (SBR), acrylonitrile butadiene rubbers (NBR) and chloroprene rubbers (CR).

In particular, the elastomeric polymer a) includes at least one monomer incorporated by polymerization, which is selected from ethylene, propylene, 1-butene, 1,2-butylene, 2,3-butylene, isobutene, isoprene, styrene, butadiene, nonconjugated dienes, 1-hexene, 1-octene, C₅-C₂₀ alkenes different therefrom, and mixtures thereof.

Preferably, the elastomeric polymer a) contains at least one diene monomer incorporated by polymerization.

In a special embodiment, the elastomeric polymer a) is an ethylene-propylene-diene rubber. In the context of the embodiments of the present invention, this term also comprises polymers having, instead of or in addition to at least one diene, at least one triply or more unsaturated polymer incorporated by polymerization.

Preferably, polymer a) includes at least one nonconjugated diene incorporated by polymerization. Suitable dienes are selected from 1,4-hexadienes, 1,6-octadienes, 2-methyl-1,5-hexadienes, 6-methyl-1,5-heptadienes, 7-methyl-1,6-octadienes, cyclohexadiene, dicyclopentadiene, methyltetrahydroindene, 5-vinylnorbornene, 5-methylnorbornene, 5-ethylidenenorbornene, 5-isopropylidene-2-norbornene, 6-chloromethyl-5-isopropenyl-2-norbornene and mixtures thereof. The polymer a) can have, instead of or in addition to at least one diene, at least one triene incorporated by polymerization. Suitable trienes are selected from 2,3-diisopropylidene-5-norbornene, 2-ethylidene-3-isopropylidene-5-norbornene, 2-propyl-2,2-norbornadiene, 1,3,7-octatriene, 1,4,9-decatriene and mixtures thereof.

Preferably, polymer a) includes at least one nonconjugated diene incorporated by polymerization, selected from dicyclopentadiene, 1,4-hexadiene, 5-methylene, 5-ethylidene and 5-isopropylidene-2-norbornene.

Preferably, the elastomeric polymer a) includes a double-bond ratio of 0 to 20 wt %, in particular 0 to 10 wt %.

Preferably, component a) is used in an amount of 5 to 75 wt % in relation to the overall weight of the flame-retardant polymer composition, in particular in an amount of 20 to 50 wt % in relation to the overall weight of the flame-retardant polymer composition.

Component b)

The flame-retardant polymer composition comprises polyarylene sulfide as component b). According to embodiments of the invention, component b) is present in the flame-retardant polymer composition as particles, or as fibers. This is achieved by mixing the elastomeric polymer a) and the polyarylene sulfide b) and optionally further components, for example by means of an internal mixer or mixing rolls, at a temperature higher than the plasticization temperature of the elastomer a) and lower than the melting point of the polyarylene sulfide b).

Preferably, component b) is present in particle form having a mean particle size in the range of 0.1 to 70 μm and/or in the form of fibers having a mean fiber diameter in the range of 0.1 to 70 μm.

Insofar as component b) is present in the form of particles, they preferably have a mean particle size in the range of 0.2 to 50 μm, particularly preferably in the range of 0.3 to 30 μm, in particular in the range of 0.4 to 20 μm, especially in the range of 0.4 to 12.5 μm, in particular in the range of 0.4 to 8 μm.

Insofar as component b) is present in the form of fibers, they preferably have a mean fiber diameter in the range of 0.2 to 50 μm, particularly preferably in the range of 0.3 to 30 μm, in particular in the range of 0.4 to 20 μm, especially in the range of 0.4 to 12.5 μm, in particular in the range of 0.4 to 8 μm.

According to embodiments of the invention, the mean particle size is determined in accordance with ISO 13320, and the mean fiber diameter is determined by image analysis.

Preferably, component b) is used in an amount of 2 to 35 wt % in relation to the overall weight of the flame-retardant polymer composition, in particular in an amount of 3 to 25 wt % in relation to the overall weight of the flame-retardant polymer composition.

In a preferred embodiment, the component b) is or includes a polyphenylene sulfide, in particular a poly-p-phenylene sulfide.

Polyarylene sulfide relates to each polymer which, in relation to the overall number of repeated units in the polymer, includes at least 50 mol-% of a repeated unit of the following formula (I):

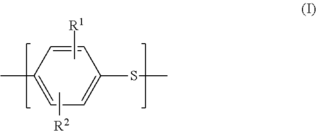

Wherein R¹ and R² are chosen to be the same or different from each other from the group consisting of hydrogen, halogen, C₁-C₁₂-alkyl, C₇-C₂₄-alkylaryl, C₇-C₂₄-aralkyl, C₆-C₂₄-aryl, C₁-C₁₂-alkoxy, C₁-C₁₂-alkylthio, C₆-Cis-aryloxy, C₆-Cis-arylthio and polyarylene sulfide, wherein each of the aromatic rings of polyarylene sulfide is unsubstituted or bears one or two substituents selected from halogen, C₁-C₁₂-alkyl, C₇-C₂₄-alkylaryl, C₇-C₂₄-aralkyl, C₆-C₂₄-aryl, C₁-C₁₂-alkoxy, C₁-C₁₂-alkylthio, C₆-Cis-aryloxy, C₆-Cis-arylthio, and wherein each of the arylene groups of polyarylene sulfide form sulfide groups via a direct C—S bond and are thereby branched or cross-linked. Preferably, the polyarylene sulfides are unsubstituted.

Preferably, both R¹ and R² are hydrogen.

In an embodiment, the polyphenylene sulfide includes at least 60 mol %, at least 70 mol %, at least 80 mol %, at least 90 mol %, at least 95 mol %, at least 99 mol % or at least 99.9 mol % of the repeated unit of formula (I) in relation to the overall number of the repeated units in the polyphenylene sulfide.

In an embodiment, the weight averaged molecular weight of the polyarylene sulfide is at least 500 g/mol, preferably from 500 g/mol to 1000,000 g/mol, preferably from 5000 g/mol to 150,000 g/mol. The weight averaged molecular weight can be determined by gel permeation chromatography (GPC) by using ASTM D5296 with polystyrene standards.

Component c)

The flame-retardant polymer composition can additionally comprise at least one curing agent as component c).

The curing agent is preferably a radical curing agent. It preferably includes a radical initiator and a cross-linking coagent.

Suitable cross-linking coagents include at least two unsaturated, preferably olefinically unsaturated sites.

In an embodiment, the radical initiators have a peroxide functionality. As examples of radical initiators, numerous organic peroxides are known and commercially available. The radical initiators, including the organic peroxides, are able to be activated over a large temperature range. The activation temperature can be described using a parameter known as half-life (T½). Typical values for half-lives of, for example 0.1 hours, 1 hour and 10 hours are indicated in degrees Celsius. For example, a T½ of 0.1 hours at 143° C. indicates that, at this temperature, half of the radical initiator decomposes within 0.1 hours. Organic peroxides having a T½ of 0.1 hours at 118° C. to 228° C. are commercially available. Such peroxides have a half-life of at least 0.1 hours at the indicated temperatures. The T½ values show the kinetics of the initial reaction during the cross-linking of the elastomeric polymer, i. e., the decomposition of the peroxide while forming a radical-containing intermediate product.

Non-limiting examples of commercially available organic peroxides to initiate curing of elastomeric polymers comprise butyl-4,4-di-(tert-butylperoxy)valerate, tert-butylperoxybenzoate, di-tert-amylperoxide, dicumylperoxide, Di(tert-butylperoxyisopropyl)benzole, 2,5-dimethyl-2,5-di(tert-butylperoxy)hexane, tert-butylcumylperoxide, 2,5-dimethyl-2,5-di(tert-butylperoxy)hex-3-ine, di-tert-butylperoxide, 3,6,9-triethyl-3,6,9-trimethyl-1,4,7-triperoxonane, 1,1,3,3-tetramethylbutyl hydroperoxide, diisopropylbenzole monohydroperoxide, cumylhydroperoxide, tert-butylhydroperoxide, tert-amylhydroperoxide, tert-butylperoxyisobutyrate, tert-amylperoxyacetate, tert-butylperoxystearylcarbonate, Di(1-hydroxycyclohexyl)peroxide, ethyl-3,3-di(tert-butylperoxy)butyrate and tert-butyl-3-isopropenylcumylperoxide.

Suitable cross-linking coagents are selected from triallylcyanurate, triallylisocyanurate, tri(methallyl)-isocyanurate, tris(diallylamine)-s-triazine, triallylphosphite, N,N-diallylacrylamide, hexaallylphosphoramide, N,N,N′,N′-tetraallyl-terephthalamide, N,N,N′,N′-tetrallylmalonamide, trivinylisocyanurate, 2,4,6-trivinylmethyltrisiloxane, bisolefines, 1,2-polybutadienes and tri(5-norbornene-2-methylene)cyanurate.

The cross-linking coagents preferably include at least two sites of an olefinic unsaturation. The unsaturated sites react with the free radical which is created at the elastomeric polymer a) and cross-link the elastomer. A commonly used cross-linking agent is triallylisocyanurate (TAIC).

When the flame-retardant polymer composition includes component c), component c) is present in an amount of 0.01 to 15 wt % in relation to the overall weight of the flame-retardant polymer composition, preferably of 0.1 to 7.5 wt % in relation to the overall weight of the flame-retardant polymer composition.

Component d)

To achieve good flame-retardant properties, it may be advantageous for the flame-retardant polymer composition to additionally comprise, as component d), at least one compound selected from compounds of magnesium, calcium, boron, aluminum, antimony, tin, zinc, organic phosphate, organic halogen compounds and mixtures thereof. Such compounds are well-known to the person skilled in the art.

In a preferred embodiment, component d) is selected from compounds of magnesium hydroxide, aluminum hydroxide, phosphorus and/or nanoclays.

Suitable phosphorus compounds are generally flame retardants acting by forming a “polyphosphoric acid” protective layer in the condensed phase. Typical phosphorus compounds are ammonium polyphosphate, melamine polyphosphate, red phosphorus, metal phosphinates (DE60115673), phosphorus- and phosphonic-acid esters and phosphazenes.

When the flame-retardant polymer composition includes component d), component d) will be present in an amount of 0.5 to 75 wt % in relation to the overall weight of the flame-retardant polymer composition, preferably 10 to 70 wt % in relation to the overall weight of the flame-retardant polymer composition.

Additives and Fillers

In addition to components a), b), c) and d), the polymer composition according to embodiments of the present invention, can include additives and fillers as further components.

Suitable additives are selected from stabilizers, processing agents, curing accelerators, pigments, colorants, adhesives, tackifying agents and waxes.

A great variety of processing agents can be used, including plasticizers and mold-release agents. Non-limiting examples of processing agents comprise carnauba wax, ester plasticizers, such as dioctyl sebacate (DOS), fatty acid salts, such as zinc stearate and sodium stearate, polyethylene wax and ceramide. In some embodiments, high-temperature processing agents are preferred. They comprise, without limitation, linear fatty alcohols, such as mixtures of C₁₀-C₂₈ alcohols, organosilicones and functionalized perfluoropolyethers. In some embodiments, the compositions include about 0.1 to about 25 wt %, preferably about 0.1 to about 15 wt %, processing agents.

Suitable fillers are selected from organic and inorganic fillers. Suitable inorganic fillers are barium sulfate, carbon black, graphite, plastic powder, such as PTFE powder, silicon dioxide, titanium dioxide, glass fiber, quartz dust, graphenes and fibers, such as mineral fibers, plastic fibers, such as, for example, polyethylene fibers having ultra-high molecular weight, carbon fibers, carbon nano tubes (CNTs), boron fibers. In different embodiments, fillers such as plastic powder, such as PTFE powder, graphite and CNT are used to improve wear resistance and other properties of molded parts, which are destined, for example, for use as dynamic sealing elements.

In a preferred embodiment, the fillers can be up to about 70 wt % of the overall weight of the compositions according to embodiments of the invention. Preferably, the compositions are 0.1 to 50 wt % filler, in relation to the overall weight of the flame-retardant polymer composition. In other embodiments, the filler is 1 to 30 wt % in relation to the overall weight of the flame-retardant polymer composition.

Carbon black is preferably used as a filler.

Preparation

The flame-retardant polymer composition according to embodiments of the present invention can include at least one uncured curable polymer or at least one cured curable polymer or at least one non-curable polymer or a combination thereof as an elastomeric polymer a).

A non-curable polymer is present if the elastomeric polymer a) has no cross-linkable molecule units (i. e. groups complementary to each other or groups complementary to a curing agent, which are suitable for curing).

Complementary curable groups, in the context of the embodiments of the present invention, are understood to be those groups which are cross-linkable by means of a chemical reaction, i. e., by forming covalent bonds or by forming salts or by non-covalent interaction.

The elastomeric polymer a) and polyarylene sulfide b) and optionally further components, can be processed to a flame-retardant polymer composition by methods common in the rubber industry. It can be processed, for example, by means of an internal mixer or mixing rolls at a temperature higher than the plasticization temperature of the elastomer a) and lower than the melting point of the polyarylene sulfide b). Other components which can be added comprise those which are commonly used in polymer compositions as described above.

The resulting polymer composition can then be molded to form polymer articles. Any common molding method known to the person skilled in the art can be used for this purpose.

If it is a curable polymer composition, it will be cured during and/or after molding. Curing is typically performed at about 100 to 250° C., preferably 150 to 200° C. A typical curing time is in the range of 0.2 to 60 minutes.

In a first embodiment, the method of preparing the curable flame-retardant polymer composition according to embodiments of the invention comprises the following steps:

i) providing at least one curable elastomer a),
ii) providing at least one polyarylene sulfide b),
iii) mixing the curable elastomer a) and the polyarylene sulfide b) at a temperature higher than the plasticization temperature of the elastomer a) and lower than the melting point of the polyarylene sulfide b),
iv) adding a curing agent, in particular a peroxide curing agent, to the polymer mixture to form a curable elastomer composition.

In a further embodiment, the method for preparing the cured flame-retardant polymer composition according to embodiments of the invention comprises the steps of:

i) providing at least one curable elastomer a),
ii) providing at least one polyarylene sulfide b),
iii) mixing the curable elastomer a) and the polyarylene sulfide b) at a temperature higher than the plasiticization temperature of the elastomer a) and lower than the melting point of the polyarylene sulfide b),
iv) adding a curing agent, in particular a peroxide curing agent, to the polymer mixture to form a curable elastomer composition,
v) curing the curable elastomer composition obtained in step iv).

In a further embodiment, the method for preparing the non-curable flame-retardant polymer composition according to embodiments of the invention comprises the steps of:

i) providing at least one non-curable elastomer a),
ii) providing at least one polyarylene sulfide b),
iii) mixing the non-curable elastomer a) and the polyarylene sulfide b) at a temperature higher than the plasiticization temperature of the elastomer a) and lower than the melting point of the polyarylene sulfide b) to form a non-curable elastomer composition.

An aspect of the present invention provides non-cured, cured and non-curable flame-retardant polymer compositions obtainable according to the above-described methods.

A preferred embodiment are moreover flame-retardant polymer compositions, comprising:

a) from 5 to 75 wt % elastomeric polymer a),
b) from 2 to 35 wt % polyarylene sulfide b),
c) from 0 to 15 wt % curing agent c),
d) from 0 to 50 wt % compounds selected from compounds of magnesium, calcium, boron, aluminum and phosphorus,
e) from 0 to 50 wt % additives,
wherein the sum of the components a), b), c), d) and e) results in 100 wt %.

In one embodiment, the flame-retardant polymer composition includes at least 50 wt % of the elastomeric polymer a), in relation to the sum of elastomeric polymer a) and polyarylene sulfide b).

In a further embodiment, the flame-retardant polymer composition includes more than 50 wt % of the elastomeric polymer a), in relation to the sum of elastomeric polymer a) and polyarylene sulfide b).

A further aspect of the invention relates to the use of a mixture including component b) and component d), as defined above, as a flame retardant.

A further aspect of the invention relates to the use of a mixture including component b) and component d), as defined above, for finishing component a) as defined above, in a flame-retardant manner.

A further aspect of the invention relates to the use of the flame-retardant polymer composition, as defined above, in automotive parts.

Embodiments of invention also relate to the use of a flame-retardant polymer composition according to embodiments of the invention for the production of a polymer article, selected from spring elements, dampening elements, seals, hoses, mats, molded parts, protective clothing etc. or as a component thereof. The article can be formed, in particular, as an endless section. A preferred embodiment are seals, especially O-rings, frame seals, radial shaft sealing rings, bellows and valve-stem seals. A further preferred embodiment is an article in the form of an endless section, in particular, for windows, or as a seal between frame and window pane.

Furthermore, embodiments of the invention relate to a flame-protected article. This article can be made exclusively of the composition according to embodiments of the invention, as a molded part, for example. Alternatively, such an article can also comprise this composition in part, in the form of a coating on a base body, for example, on a fabric, for example.

Embodiments of the invention also relate to an elastic composite element, suitable for vibration damping and springing, having a base body provided with at least one coating made of the composition according to embodiments of the invention at least in parts or in sections on its external surface, or on its entire external surface, as the case may be.

In a suitable embodiment, a flame-retardant polymer composition according to embodiments of the invention is fixedly and integrally bonded to a base body as a coating. The coating can be applied to the base body by assembly, extrusion, pressing, spraying etc. A composite bond can thus be created between the base body and the coating.

It can also be provided that the base body is provided with a reinforcement, for example by means of fibers, in particular glass fibers, plastic fibers, CFK fibers, GFK fibers, a textile material, or fabric, or the like.

### Examples

The following examples are for the illustration of the embodiments of the invention without being limiting in any way.

The following examples show that the flame-retardant property of a polyolefin polymer of ethylene-propylene-diene rubbers, magnesium hydroxide and aluminum hydroxide can be substantially improved by poly-p-phenylene sulfide.

The following initial components were used for the examples.

Materials Used:

EPDM1: ethylene-propylene rubber, ethylene content of 53 wt %; ENB content 6.0 wt %, Mooney viscosity 25 (ML1+4 @121° C.)
EPDM2: ethylene-propylene rubber, oil content 50 wt %, ethylene content 63 wt %; ENB content 4.5 wt %, Mooney viscosity 52 (ML1+4 @121° C.)
PPS: poly-p-phenylene sulfide, particle size 20 μm
Antioxidant: 2,2,4-trimethyl-1,2-dihydrochinoline, polymerized
Peroxide: dicumylperoxide
Coagent: triallylcyanurate
DOA: plasticizer, dioctyl adipate
Carbon black: carbon black, lampblack N-550
ATH: aluminum hydroxide, vinylsilanized
MDH: magnesium hydroxide, vinylsilanized
SiOx: silicic acid, vinylsilanized
Processing agent 1: resorcine-bisdiphenyl phosphate (RDP)
Processing agent 2: polyoxyehtylene octadecyl ether phosphate

The preparation of the composition was performed in an internal mixer and mixing rolls suitable for the preparation of rubber mixtures.

The studies were performed on test plates 2 mm thick, cross-linked for 5 min at 180° C. and postvulcanized for 4 h at 150° C. The following rubber mixtures were prepared and tested with regard to various parameters relevant for sealing applications. The compositions are listed in table 1.

TABLE 1

| Constituents | E1* [phr] | C1^{#} [phr] |
|---|---|---|
| EPDM | 90 | 90 |
| EPDM 2 oil extended | 20 | 20 |
| Dioctyl adipate | 10 | 10 |
| Carbon black | 4 | 4 |
| ATH | 190 | 190 |
| MDH | 10 | 10 |
| SiOₓ | 15 | 15 |
| Antioxidant | 1.5 | 1.5 |
| Peroxide | 7 | 7 |
| Coagent | 5 | 5 |
| Processing agent 1 | 2 | 2 |
| Processing agent 2 | 1 | 1 |
| PPS | 25 | — |

[phr] . . . parts per hundred rubber
*example according to an embodiment of the invention,
^{#}comparative example

Sealing Application:

Comparative mixture C1: The cross-linked material shows a tensile strength of 14.8 N/mm² and a compression set of 24% after 24 h at 150° C. The tear propagation strength in accordance with DIN ISO 34-1: 2016-09 B/a without cut is 14.0 N/mm, in accordance with DIN ISO 34-1: 2016-09 B/b with cut 7.9 N/mm.

Inventive composition E1: The cross-linked material shows a tensile strength of 11.4 N/mm² and a compression set of 16% after 24 h at 150° C. The tear propagation strength in accordance with DIN ISO 34-1: 2016-09 B/a without cut is 15.2 N/mm, in accordance with DIN ISO 34-1: 2016-09 B/b with cut 9.3 N/mm.

Safety of Flammability Test According to UL 94:

The flammability test according to UL 94 was performed and had the following result:

Classification of E1: UL 94 V0

Classification of C1: UL 94 V1

The mixture E1 according to an embodiment of the invention shows a substantial improvement of the safety of flammability properties as against comparative C1.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A flame-retardant polymer composition, comprising:
a) at least one elastomeric polymer including at least one monomer incorporated by polymerization, wherein the at least one monomer comprises at least one of C₂-C₃₀ alkylenes, and
b) polyarylene sulfide,
wherein the polyarylene sulfide is present in a particle form and/or in a fiber form.

2. The flame-retardant polymer composition according to claim 1, wherein the elastomeric polymer comprises a curable elastomer.

3. The flame-retardant polymer composition according to claim 2, further comprising
c) at least one curing agent.

4. The flame-retardant polymer composition according to claim 1, additionally including further comprising
d) at least one composition of an element selected from the group consisting of compounds of magnesium, compounds of calcium, compounds of boron, compounds of aluminum, compounds of antimony, compounds of tin, compounds of zinc, organic phosphorus compounds, organic halogen compounds, and mixtures thereof.

5. The flame-retardant polymer composition according to claim 1, wherein the elastomeric polymer a) includes at least one diene monomer incorporated by polymerization.

6. The flame-retardant polymer composition according to claim 1, wherein the at least one elastomeric polymer a) includes monomers incorporated by polymerization, wherein the monomers are selected from the group consisting of ethylene, propylene, 1-butene, 1,2-butylene, 2,3-butylene, isobutene, isoprene, styrene, butadiene, 1-hexene, 1-octene, C₅-C₂₀ alkenes different therefrom, and mixtures thereof.

7. The flame-retardant polymer composition according to claim 1, wherein the at least one elastomeric polymer a) has a double-bond content of 0 to 20 wt %, in particular of 0 to 10 wt %.

8. The flame-retardant polymer composition according to claim 1, wherein component b) is present in particle form having a mean particle size in the range from 0.1 to 70 μm and/or in fiber form having a mean fiber diameter in the range from 0.1 to 70 μm.

9. The flame-retardant polymer composition according to claim 1, wherein component b) is used in an amount of 2 to 35 wt % in relation to the overall weight of the flame-retardant polymer composition.

10. The flame-retardant polymer composition according to claim 1, comprising:
a) from 5 to 75 wt % of the elastomeric polymer a),
b) from 2 to 35 wt % of the polyarylene sulfide b),
c) from 0 to 15 wt % of a curing agent c),
d) from 0 to 50 wt % of compounds selected from the group consisting of compounds of magnesium, compounds of calcium, compounds of boron, compounds of aluminum, and compounds of phosphorus,
e) from 0 to 50 wt % of additives,
wherein the sum of the components a), b), c), d) and e) results in 100 wt %.

11. A method of producing a curable flame-retardant polymer composition, the method comprising the steps of:
i) providing at least one curable elastomer a),
ii) providing at least one polyarylene sulfide b),
iii) mixing the curable elastomer a) and the polyarylene sulfide b) at a temperature higher than the plasticization temperature of the elastomer a) and lower than the melting point of the polyarylene sulfide b), and
iv) adding a curing agent to the polymer mixture to form a curable elastomer composition.

12. A method of producing a curable flame-retardant polymer composition, the method comprising the steps of:
i) providing at least one curable elastomer a),
ii) providing at least one polyarylene sulfide b),
iii) mixing the curable elastomer a) and the polyarylene sulfide b) at a temperature higher than the plasticization temperature of the elastomer a) and lower than the melting point of the polyarylene sulfide b),
iv) adding a curing agent to the polymer mixture to form a curable elastomer composition, and
v) curing the curable elastomer composition obtained in step iv).

13-15. (canceled)

16. The flame-retardant polymer composition according to claim 2, wherein the curable elastomers comprises radically curable elastomers.

17. The flame-retardant polymer composition according to claim 2, wherein the curable elastomers comprises peroxidically curable elastomers.

18. The flame-retardant polymer composition according to claim 6, wherein the elastomeric polymer a) is an ethylene-propylene-diene rubber.

19. The method according to claim 11, wherein the curing agentin comprises a peroxide curing agent.

20. The method according to claim 12, wherein the curing agentin comprises a peroxide curing agent.
